(19) United States
(12) Patent Application Publication
(10) Pub. No.: US 2013/0138499 A1
(43) Pub. Date: May 30, 2013

(54) USAGE MEASURENT TECHNIQUES AND SYSTEMS FOR INTERACTIVE ADVERTISING

(71) Applicants: Peter Henry Tu, Niskayuna, NY (US); Mark Lewis Grabb, Burnt Hills, NY (US); Xiaoming Liu, Schenectady, NY (US); Ting Yu, Niskayuna, NY (US); Yi Yao, Niskayuna, NY (US); Dashan Gao, Niskayuna, NY (US); Ming-Ching Chang, Niskayuna, NY (US)

(72) Inventors: Peter Henry Tu, Niskayuna, NY (US); Mark Lewis Grabb, Burnt Hills, NY (US); Xiaoming Liu, Schenectady, NY (US); Ting Yu, Niskayuna, NY (US); Yi Yao, Niskayuna, NY (US); Dashan Gao, Niskayuna, NY (US); Ming-Ching Chang, Niskayuna, NY (US)

(73) Assignee: General Electric Company, Schenectady, NY (US)

(21) Appl. No.: 13/308,386

(22) Filed: Nov. 30, 2011

(51) Int. Cl. G06Q 30/02

(52) U.S. Cl. 705/14.41; 705/14.68

(57) ABSTRACT

An advertising system is disclosed. In one embodiment, the system includes an advertising display configured to provide an advertisement to potential customers and a camera configured to capture images of the potential customers when the potential customers pass the advertising display. The system may also include an image processing system having a processor and a memory. The memory may include application instructions for execution by the processor, and the image processing system may be configured to execute the application instructions to derive usage characteristics of the potential customers with respect to the advertising display through analysis of the captured images. Additional methods, systems, and articles of manufacture are also disclosed.

### BACKGROUND

The present disclosure relates generally to advertising and, in some embodiments, to measuring or increasing the effectiveness of interactive advertising.

Advertising of products and services is ubiquitous. Billboards, signs, and other advertising media compete for the attention of potential customers. Recently, interactive advertising systems that encourage user involvement have been introduced. While advertising is prevalent, it may be difficult to determine the efficacy of particular forms of advertising. For example, it may be difficult for an advertiser (or a client paying the advertiser) to determine whether a particular advertisement is effectively resulting in increased sales or interest in the advertised product or service. This may be particularly true of signs or interactive advertising systems. Because the effectiveness of advertising in drawing attention to, and increasing sales of, a product or service is important in deciding the value of such advertising, there is a need to better evaluate and determine the effectiveness of advertisements provided in such manners. Additionally, there is a need to increase and retain interest of potential customers in advertising content provided by interactive advertising systems.

### BRIEF DESCRIPTION

Certain aspects commensurate in scope with the originally claimed invention are set forth below. It should be understood that these aspects are presented merely to provide the reader with a brief summary of certain forms various embodiments of the presently disclosed subject matter might take and that these aspects are not intended to limit the scope of the invention. Indeed, the invention may encompass a variety of aspects that may not be set forth below.

Some embodiments of the present disclosure may generally relate to advertising, and to monitoring and increasing the effectiveness of such advertising. Further, some embodiments relate to enhancing user experiences with interactive advertising content. For example, in one embodiment a system includes an advertising display configured to provide an advertisement to potential customers and a camera configured to capture images of the potential customers when the potential customers pass the advertising display. The system may also include an image processing system having a processor and a memory. The memory may include application instructions for execution by the processor, and the image processing system may be configured to execute the application instructions to derive usage characteristics of the potential customers with respect to the advertising display through analysis of the captured images.

In another embodiment, a method includes receiving imagery of a viewed area from a camera. The viewed area may be proximate an advertising station of an advertising system such that one or more potential customers may receive an advertisement from the advertising station when the one or more potential customers are within the viewed area. The method may also include electronically processing the received imagery to determine usage characteristics for the advertising station.

In an additional embodiment, a manufacture includes one or more non-transitory, computer-readable media having executable instructions stored thereon. The executable instructions may include instructions adapted to receive image data depicting one or more potential customers near an advertising station. The executable instructions may also include instructions adapted to electronically process the image data: to determine a number of potential-customer encounters at the advertising station, to determine demographic information for the potential customers, to determine emotional responses by the potential customers to content provided by the advertising station, to identify potential customers that have had multiple encounters with the advertising station, and to detect multiple encounters between at least one of the potential customers and the advertising station. Various refinements of the features noted above may exist in relation to various aspects of the subject matter described herein. Further features may also be incorporated in these various aspects as well. These refinements and additional features may exist individually or in any combination. For instance, various features discussed below in relation to one or more of the illustrated embodiments may be incorporated into any of the described embodiments of the present disclosure alone or in any combination. Again, the brief summary presented above is intended only to familiarize the reader with certain aspects and contexts of the subject matter disclosed herein without limitation to the claimed subject matter.

### DRAWINGS

These and other features, aspects, and advantages of the present technique will become better understood when the following detailed description is read with reference to the accompanying drawings in which like characters represent like parts throughout the drawings, wherein:

FIG. 1 is a block diagram of an advertising system including an advertising station having a data processing system in accordance with an embodiment of the present disclosure;

FIG. 2 is a block diagram of an advertising system including a data processing system and advertising stations that communicate over a network in accordance with an embodiment of the present disclosure;

FIG. 3 is a block diagram of a processor-based device or system for providing the functionality described in the present disclosure and in accordance with an embodiment of the present disclosure;

FIG. 4 depicts a person walking by an advertising station in accordance with an embodiment of the present disclosure;

FIG. 5 is a block diagram representing routines and operation of a data processing system in accordance with an embodiment of the present disclosure;

FIG. 6 is a block diagram of a hierarchical taxonomy of objects that may be used to characterize image data in accordance with an embodiment of the present disclosure;

FIG. 7 is a flowchart for selecting and outputting advertising content based on image analysis in accordance with an embodiment of the present disclosure;

FIG. 8 is a flowchart for deriving usage characteristics for potential customers near an advertising station and using such information in accordance with an embodiment of the present disclosure;

FIG. 9 depicts a group of individuals encountering an advertising station in accordance with an embodiment of the present disclosure;

FIG. 10 depicts multiple advertising stations that a potential customer may interact with in accordance with an embodiment of the present disclosure;

FIG. 11 generally represents a method for determining that a potential customer has had multiple encounters with one or more advertising stations in accordance with one embodiment;

FIG. 12 is a block diagram representing routines for identifying potential customers and tracking customer interactions in accordance with an embodiment of the present disclosure;

FIG. 13 is a flowchart representing a method for selecting content for output to a potential customer based on previous interactions in accordance with an embodiment of the present disclosure;

FIGS. 14-16 generally depict a sequence of encounters by a potential customer with an advertising station in accordance with an embodiment of the present disclosure;

FIG. 17 is a flowchart representing a method for interacting with a potential customer through one or more virtual characters in accordance with an embodiment of the present disclosure; and

FIGS. 18 and 19 generally depict interactions between a virtual character and a potential customer in accordance with an embodiment of the present disclosure.

### DETAILED DESCRIPTION

One or more specific embodiments of the presently disclosed subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. When introducing elements of various embodiments of the present techniques, the articles “a,” “an,” “the,” and “said” are intended to mean that there are one or more of the elements. The terms “comprising,” “including,” and “having” are intended to be inclusive and mean that there may be additional elements other than the listed elements.

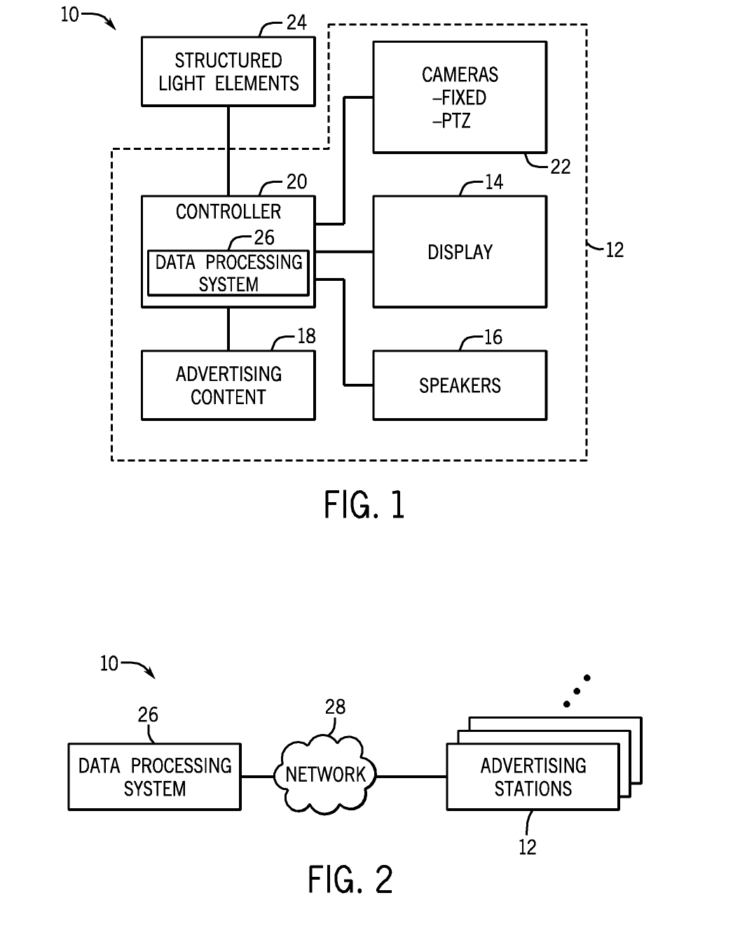

A system 10 is depicted in FIG. 1 in accordance with one embodiment. The system 10 may be an advertising system including an advertising station 12 for outputting advertisements to nearby persons (i.e., potential customers). The depicted advertising station 12 includes a display 14 and speakers 16 to output advertising content 18 to potential customers. In some embodiments, the advertising content 18 may include multi-media content with both video and audio. Any suitable advertising content 18 may be output by the advertising station 12, including video only, audio only, and still images with or without audio, for example.

The advertising station 12 includes a controller 20 for controlling the various components of the advertising station 12 and for outputting the advertising content 18. In the depicted embodiment, the advertising station 12 includes one or more cameras 22 for capturing image data from a region near the display 14. For example, the one or more cameras 22 may be positioned to capture imagery of potential customers using or passing by the display 14. The cameras 22 may include either or both of at least one fixed camera or at least one Pan-Tilt-Zoom (PTZ) camera. For instance, in one embodiment, the cameras 22 include four fixed cameras and four PTZ cameras.

Structured light elements 24 may also be included with the advertising station 12, as generally depicted in FIG. 1. For example, the structured light elements 24 may include one or more of a video projector, an infrared emitter, a spotlight, or a laser pointer. Such devices may be used to actively promote user interaction. For example, projected light (whether in the form of a laser, a spotlight, or some other directed light) may be used to direct the attention of a user of the advertising system 12 to a specific place (e.g., to view or interact with specific content), may be used to surprise a user, or the like. Additionally, the structured light elements 24 may be used to provide additional lighting to an environment to promote understanding and object recognition in analyzing image data from the cameras 22. This may take the form of basic illumination as well as the use of structured light for the purposes of ascertaining the three dimensional shape of objects in the scene through the use of standard stereo methods. Although the cameras 22 are depicted as part of the advertising station 12 and the structured light elements 24 are depicted apart from the advertising station 12 in FIG. 1, it will be appreciated that these and other components of the system 10 may be provided in other ways. For instance, while the display 14, one or more cameras 22, and other components of the system 10 may be provided in a shared housing in one embodiment, these components may be also be provided in separate housings in other embodiments.

Further, a data processing system 26 may be included in the advertising station 12 to receive and process image data (e.g., from the cameras 22). Particularly, in some embodiments, the image data may be processed to determine various user characteristics and track users within the viewing areas of the cameras 22. For example, the data processing system 26 may analyze the image data to determine each person's position, moving direction, tracking history, body pose direction, and gaze direction or angle (e.g., with respect to moving direction or body pose direction). Additionally, such characteristics may then be used to infer the level of interest or engagement of individuals with the advertising station 12.

Although the data processing system 26 is shown as incorporated into the controller 20 in FIG. 1, it is noted that the data processing system 26 may be separate from the advertising station 12 in other embodiments. For example, in FIG. 2, the system 10 includes a data processing system 26 that connects to one or more advertising stations 12 via a network 28. In such embodiments, cameras 22 of the advertising stations 12 (or other cameras' monitoring areas about such advertising stations) may provide image data to the data processing system 26 via the network 28. The data may then be processed by the data processing system 26 to determine desired characteristics and levels of interest by imaged persons in advertising content, as discussed below. And the data processing system 26 may output the results of such analysis, or instructions based on the analysis, to the advertising stations 12 via the network 28.

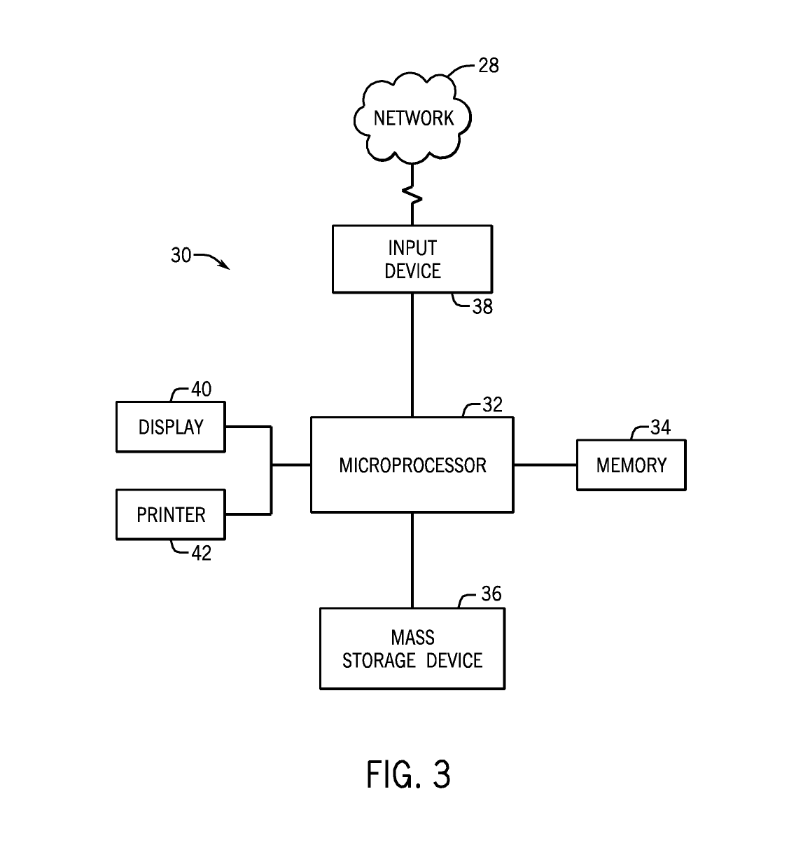

Either or both of the controller 20 and the data processing system 26 may be provided in the form of a processor-based system 30 (e.g., a computer), as generally depicted in FIG. 3 in accordance with one embodiment. Such a processor-based system may perform the functionalities described in this disclosure, such as data analysis, customer identification, customer tracking, usage characteristics determination, content selection, determination of body pose and gaze directions, and determination of user interest in advertising content. The depicted processor-based system 30 may be a general-purpose computer, such as a personal computer, configured to run a variety of software, including software implementing all or part of the functionality described herein. Alternatively, the processor-based system 30 may include, among other things, a mainframe computer, a distributed computing system, or an application-specific computer or workstation configured to implement all or part of the present technique based on specialized software and/or hardware provided as part of the system. Further, the processor-based system 30 may include either a single processor or a plurality of processors to facilitate implementation of the presently disclosed functionality.

In general, the processor-based system 30 may include a microcontroller or microprocessor 32, such as a central processing unit (CPU), which may execute various routines and processing functions of the system 30. For example, the microprocessor 32 may execute various operating system instructions as well as software routines configured to effect certain processes. The routines may be stored in or provided by an article of manufacture including one or more non-transitory computer-readable media, such as a memory 34 (e.g., a random access memory (RAM) of a personal computer) or one or more mass storage devices 36 (e.g., an internal or external hard drive, a solid-state storage device, an optical disc, a magnetic storage device, or any other suitable storage device). The routines (which may also be referred to as executable instructions or application instructions) may be stored together in a single, non-transitory, computer-readable media, or they may be distributed across multiple, non-transitory, computer-readable media that collectively store the executable instructions. In addition, the microprocessor 32 processes data provided as inputs for various routines or software programs, such as data provided as part of the present techniques in computer-based implementations (e.g., advertising content 18 stored in the memory 34 or the storage devices 36, and image data captured by cameras 22).

Such data may be stored in, or provided by, the memory 34 or mass storage device 36. Alternatively, such data may be provided to the microprocessor 32 via one or more input devices 38. The input devices 38 may include manual input devices, such as a keyboard, a mouse, or the like. In addition, the input devices 38 may include a network device, such as a wired or wireless Ethernet card, a wireless network adapter, or any of various ports or devices configured to facilitate communication with other devices via any suitable communications network 28, such as a local area network or the Internet. Through such a network device, the system 30 may exchange data and communicate with other networked electronic systems, whether proximate to or remote from the system 30. The network 28 may include various components that facilitate communication, including switches, routers, servers or other computers, network adapters, communications cables, and so forth.

Results generated by the microprocessor 32, such as the results obtained by processing data in accordance with one or more stored routines, may be reported to an operator via one or more output devices, such as a display 40 or a printer 42. Based on the displayed or printed output, an operator may request additional or alternative processing or provide additional or alternative data, such as via the input device 38. Communication between the various components of the processor-based system 30 may typically be accomplished via a chipset and one or more busses or interconnects which electrically connect the components of the system 30.

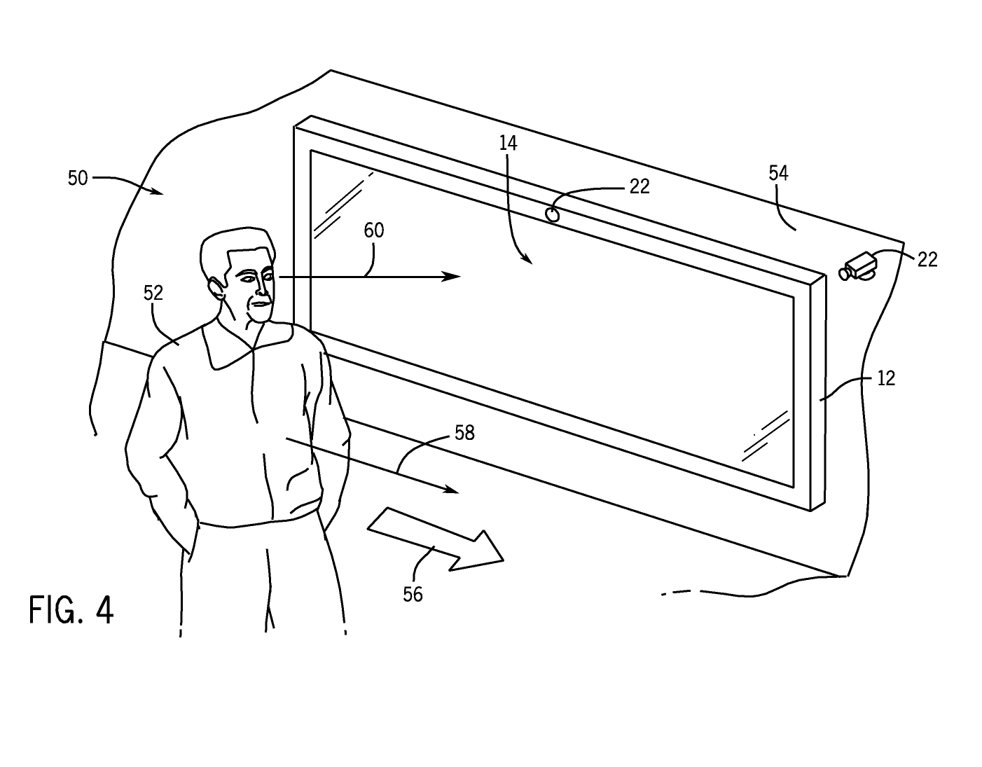

Operation of the advertising system 10, the advertising station 12, and the data processing system 26 may be better understood with reference to FIG. 4, which generally depicts an advertising environment 50. In the illustrated embodiment, a person 52 is passing an advertising station 12 mounted on a wall 54. One or more cameras 22 may be provided in the environment 50, such as within a housing of the display 14 of the advertising station 12 or set apart from such a housing. For instance, one or more cameras 22 may be installed within the advertising station 12 (e.g., in a frame about the display 14), across a walkway from the advertising station 12, on the wall 54 apart from the advertising station 12, or the like. The cameras 22 may capture imagery of the person 52. As the person 52 walks by the advertising station 12, the person 52 may travel in a direction 56. Also, as the person 52 walks in the direction 56, the body pose of the person 52 may be in a direction 58, while the gaze direction of the person 52 may be in a direction 60 toward display 14 of the advertising station 12 (e.g., the person may be viewing advertising content on the display 14).

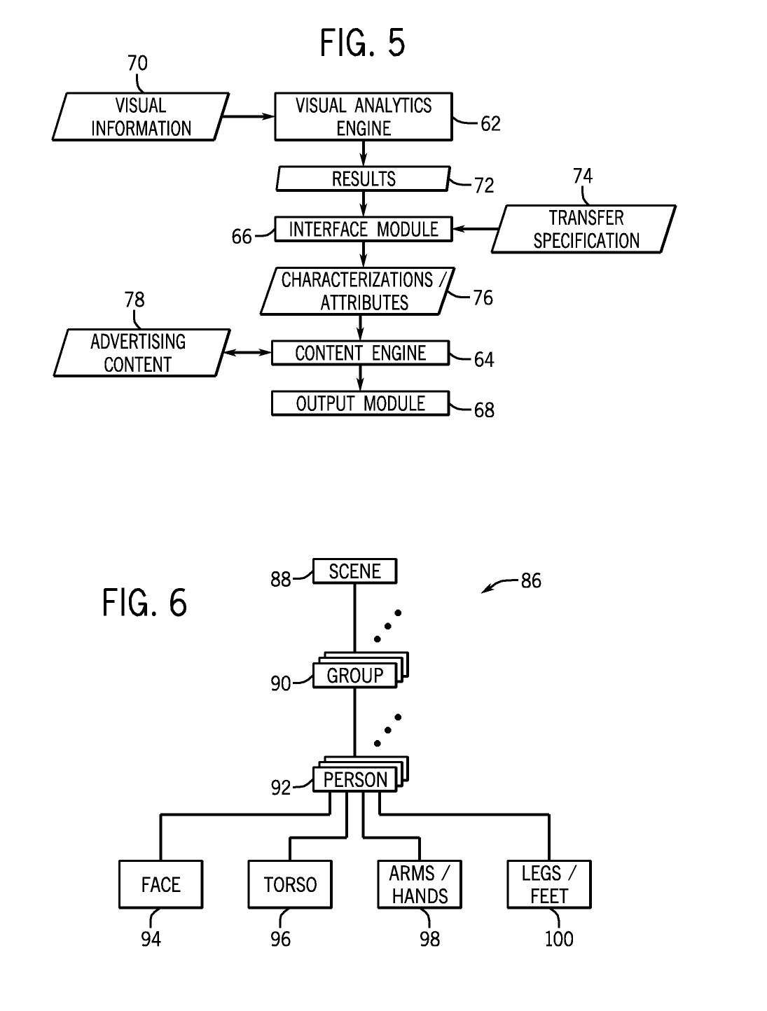

Unlike previous approaches in which interactive advertising applications are the result of a comingling of video content engines and analytics mechanisms for acquiring user actions (which may result in ad-hoc approaches with a succession of one-off developments unsuitable for large-scale deployments), in at least one embodiment of the present disclosure a content engine is separated from an analytics engine. An interface specification may then be used to facilitate information transfer between the analytics and content engines. Accordingly, in one such embodiment generally depicted in FIG. 5, the data processing system 26 may include a visual analytics engine 62, a content engine 64, an interface module 66, and an output module 68. These engines and modules may be provided in the form in the application instructions (e.g., stored in a memory 34 or storage device 36) executable by the processor of the data processing system to carry out certain functionalities. The visual analytics engine 62 may perform analysis of visual information 70 received by the data processing system 26. The visual information 70 may include representations of human activity (e.g., in video or still images), such as a potential customer interacting with the advertising station 12. Generally, the visual analytics engine 62 is adapted to receive and process a variety of customer activity that may be captured, quantized, and presented to the visual analytics engine 62.

The visual analytics engine 62 may perform desired analysis (e.g., face detection, user identification, and user tracking) and provide results 72 of the analysis to the interface module 66. In one embodiment, the results 72 include information about individuals depicted in the visual information 70, such as position, location, direction of movement, body pose direction, gaze direction, biometric data, and the like. The interface module 66 enables some or all of the results 72 to be input to the content engine 64 in accordance with a transfer specification 74. Particularly, in one embodiment the interface module 66 outputs characterizations 76 classifying objects depicted in the visual information 70 and attributes of such objects. Based on these inputs, the content engine 64 may select advertising content 78 for output to the user via the output module 68.

In some embodiments, the transfer specification 74 may be a hierarchical, object-oriented data structure, and may include a defined taxonomy of objects and associated descriptors to characterize the analyzed visual information 70. For instance, in an embodiment generally represented by block diagram 86 in FIG. 6, the taxonomy of objects may include a scene object 88, group objects 90, person objects 92, and one or more body-part objects that further characterize the persons 92. Such body-part objects include, in one embodiment, face objects 94, torso objects 96, arms and hands objects 98, and legs and feet objects 100.

Further, each object may have associated attributes (also referred to as descriptors) that describe the objects. Some of these attributes are static and invariant over time, while others are dynamic in that they evolve with time and may be represented as a time series that can be indexed by time. For example, attributes of the scene object 88 may include a time series of raw 2D imagery, a time series of raw 3D range imagery, an estimate of the background without people or other transitory objects (which may be used by the content engine for various forms of augmented reality), and a static 3D site model of the scene (e.g., floor, walls, and furniture, which may be used for creating novel views of the scene in a game-like manner).

The scene object 88 may include one or more group objects 90 having their own attributes. For example, the attributes of each group 90 may include a time series of the size of the group (e.g., number of individuals), a time series of the centroid of the group (e.g., in terms of 2D pixels and 3D spatial dimensions), and a time series of the bounding box of the group (e.g., in both 2D and 3D). Additionally, attributes of the group objects 90 may include a time series of motion fields (or cues) associated with the group. For example, for each point in time, these motion cues may include, or may be composed of, dense representations (such as optical flow) or sparse representations (such as the motion associated with interest points). For the dense representation, a multi-dimensional matrix that can be indexed based on pixel location may be used, and each element in the matrix may maintain vertical and horizontal motion estimates. For the sparse representation, a list of interest points may be maintained, in which each interest point includes a 2D location and a 2D motion estimate.

The group objects 90 may, in turn, include one or more person objects 92. Attributes of the person objects 92 may include a time series of the 2D and 3D location of the person, a general appearance descriptor of the person (e.g., to allow for person reacquisition and providing semantic descriptions to the content engine), a time series of the motion cues (e.g., sparse and dense) associated with the vicinity of the person, demographic information (e.g., age, gender, or cultural affiliations), and a probability distribution associated with the estimated demographic description of the person. Further attributes may also include a set of biometric signatures that can be used to link a person to prior encounters and a time series of a tree-like description of body articulation. In addition, higher level motion and appearance cues may be associated with each interest point.

Particular anatomies of each person may be defined as additional objects, such as face object 94, torso object 96, arms and hands object 98, and legs and feet object 100. Attributes associated with the face object 94 may include a time series of 3D gaze direction, a time series of facial expression estimates, a time series of location of the face (e.g., in 2D and 3D), and a biometric signature that can be used for recognition. Attributes of the torso object 96 may include a time series of the location of the torso and a time series of the orientation of the torso (e.g., body pose). Attributes of the arms and hands object 98 may include a time series of the positions of the hands (e.g., in 2D and 3D), a time series of the articulations of the arms (e.g., in 2D and 3D), and an estimate of possible gestures and actions of the arms and hands. Further, attributes of the legs and feet object 100 may include a time series of the location of the feet of the person. While numerous attributes and descriptors have been provided above for the sake of explanation, it will be appreciated that other objects or attributes may also be used in full accordance with the present techniques.

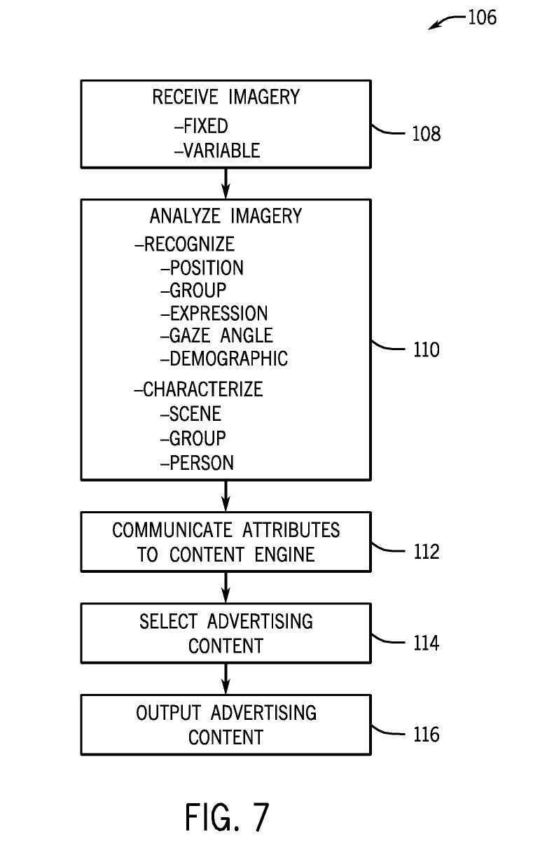

A method to facilitate interactive advertising is generally represented by flowchart 106 depicted in FIG. 7 in accordance with one embodiment. The method may include receiving imagery of a viewed area about an advertising station 12 (block 108), such as an area in which a potential customer may be positioned to receive an advertisement from the advertising station 12. In certain embodiments, the received imagery may be captured by the one or more cameras 22, such as a fixed-position camera or a variable-positioned camera (e.g., allowing the area viewed by that camera to vary over time).

The method may further include analyzing the received imagery (block 110). For example, analysis of the imagery may be performed by the analytics engine 62 described above, and may use a hierarchal specification to characterize the received imagery. For such characterization, the analysis may include recognizing certain information from the imagery and about persons therein, such as the position of an individual, the existence of groups of individuals, the expression of an individual, the gaze direction or angle of an individual, and demographic information for an individual.

Based on the analysis, various objects (e.g., scene, group, and person) may be characterized by determining attributes of the objects, and the attributes may be communicated to the content engine (block 112). In this manner, the content engine may receive scene level descriptions, group level descriptions, person level descriptions, and body part level descriptions in semantically rich context that represents the imaged view (and objects therein) in a hierarchical way. In some embodiments, the content engine may then select advertising content from a plurality of such content based on the communicated attributes (block 114) and may output the selected advertising content to potential customers (block 116). The selected advertising content may include any suitable content, such as a video advertisement, a multimedia advertisement, an audio advertisement, a still image advertisement, or a combination thereof. Additionally, the selected content may be interactive advertising content in embodiments in which the advertising station 12 is an interactive advertising station.

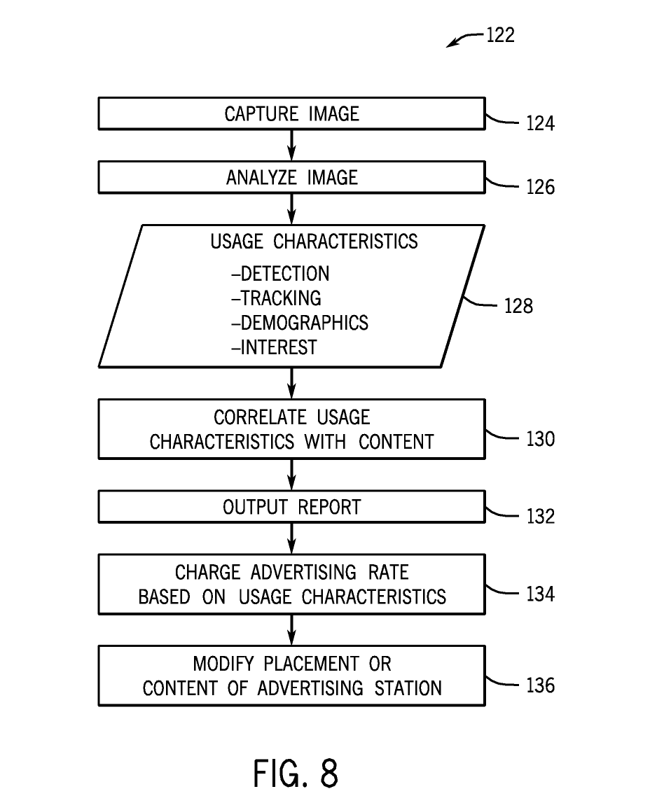

In some embodiments, the advertising system 10 may determine usage characteristics of the one or more advertising stations 12 (e.g., through any of an array of computer vision techniques) to provide feedback on how the advertising stations 12 are being used and on the effectiveness of the advertising stations 12. For instance, in one embodiment generally represented by flowchart 122 in FIG. 8, a method may include capturing one or more images (e.g., still or video images) of a potential customer encountering (e.g., interacting with or merely passing by) an advertising station 12 (block 124). The captured images may be analyzed (block 126) using an array of computer vision techniques to derive usage characteristics 128. For example, analysis of the captured imagery may include person detection, person tracking, demographic analysis, affective analysis, and social network analysis. The usage characteristics may generally capture marketing information relevant to measuring the effectiveness of the advertising station 12 and its output content.

The usage characteristics may be correlated with the content provided to users (block 130) at the time of image capture to allow generation and output of a report (block 132) detailing measurements of effectiveness of a given advertising station 12 and the associated advertising content. Based on such information, an owner of the advertising station 12 may charge or modify advertising rates to clients (block 134). Similarly, based on such information the owner (or a representative) may modify placement, presentation, or content of the advertising station (block 136), such as to achieve better performance and results.

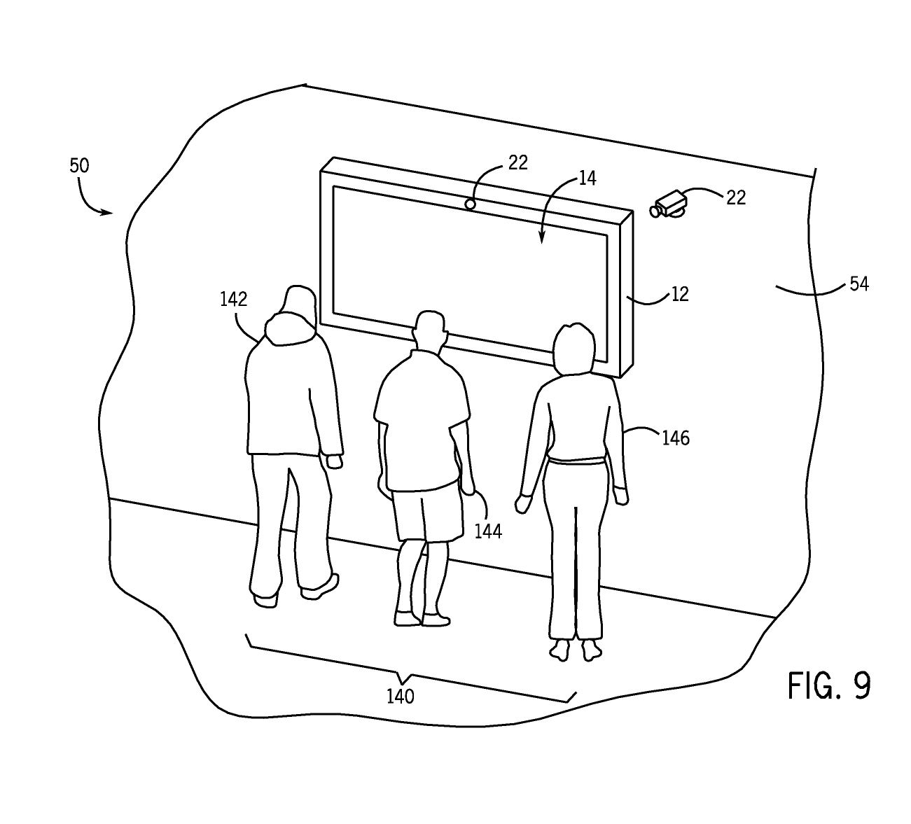

Examples of such usage of characteristics are provided below with reference to FIG. 9, in which a group 140 of individuals is interacting with an advertising station 12 in accordance with one embodiment. In the depicted embodiment, the group 140 includes individual persons 142, 144, and 146 that are interacting with the advertising station 12. The cameras 22 may capture video or still image data of the area in which the group 140 is located. As noted above, the advertising station 12 may be an interactive advertising station in some embodiments.

A data processing system 26 associated with the advertising station 12 may analyze the imagery from the cameras 22 to provide measurements indicative of the effectiveness of the advertising station 12. For example, the data processing system 26 may analyze the captured imagery using person detection capabilities to generate statistics regarding the number of people that have potential for interacting with the advertising station 12 (e.g., the number of people that enter the viewed area over a given time period) and the dwell time associated with each encounter (i.e., the time a person spends viewing or interacting with the advertising station 12). Additionally, the data processing system 26 may use soft biometric features or measures (e.g., from face recognition) to estimate the age, the gender, and the cultural affiliation of each individual (e.g., allowing capture of usage characteristics and effectiveness by demographic group, such as adults vs. kids, men vs. women, younger adults vs. older adults, and the like). Group size and leadership roles for groups of individuals may also be determined using social analysis methods.

Further, the data processing system 26 may provide affective analysis of the received image data. For example, facial analysis may be performed on persons depicted in the image data to determine a time series of gaze directions of those persons with respect to the advertising station display 14 to allow for analysis of estimated interest (e.g., interest may be inferred from the length of time that a potential customer views a particular object or views the advertising content) with respect to various virtual objects provided on the display 14. Facial expression and body pose data may also be used to infer the emotional response of each individual with respect to the content produced by the interactive advertising station 12.

The usage characteristics may also include relationships over a period of time. For instance, through the use of biometric at a distance measures, as well as RF signals that can be detected from electronic devices of persons near an advertising station 12, an association can be made with respect to individuals that have multiple encounters with a given advertising station 12. Further, such information may also be used to link individuals across multiple advertising stations 12 of the advertising system 10. Such information allows the generation of statistics regarding the long term space-time relationships between customers and the advertising system 10. Still further, in one embodiment an advertising station 12 may output a coded coupon to an individual for a given service or piece of merchandise. In such an embodiment, usage of such a coupon may be received by the advertising system 10, allowing for a direct measure of the effectiveness of the given advertising station 12 and its output content.

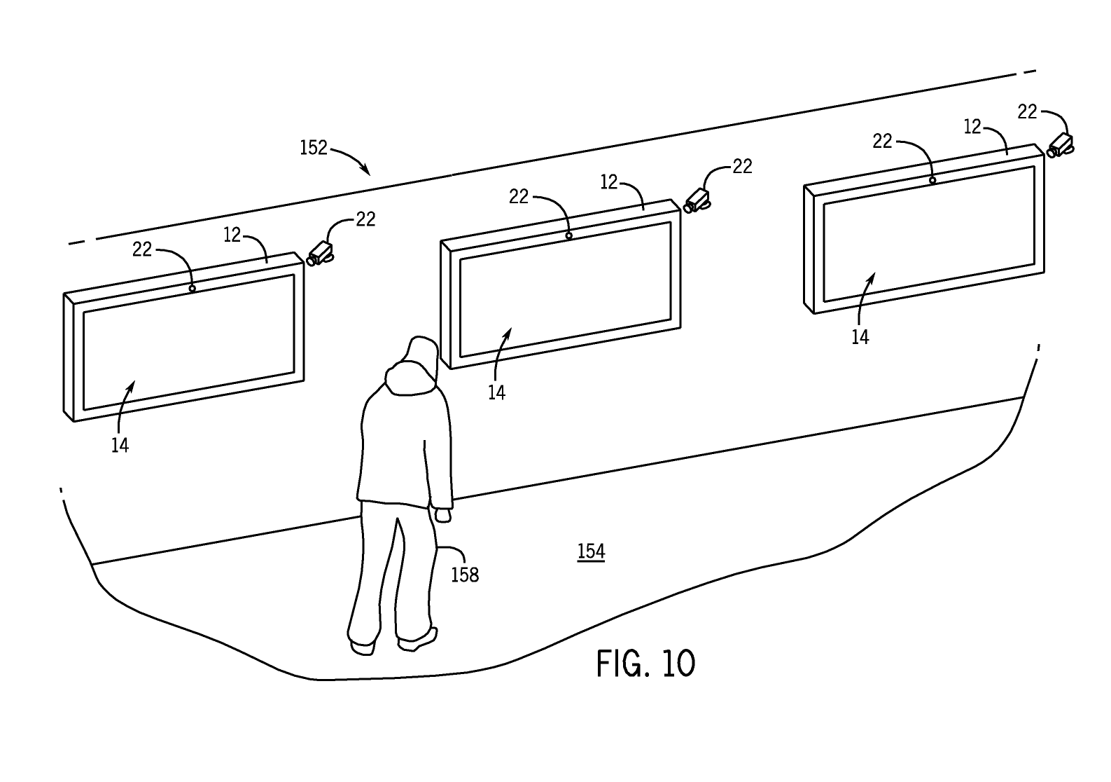

In one embodiment, an advertising environment 152 may include a plurality of advertising stations 12, as generally depicted in FIG. 10 in accordance with one embodiment. In the presently depicted embodiment, the environment 152 includes a walkway 154 and a wall including the advertising stations 12. Cameras 22 may be provided to capture images of a potential customer 158 passing by, or interacting with, the advertising stations 12 as the individual proceeds along the walkway 154. Although the advertising stations 12 are somewhat near each other in the present illustration, it will be appreciated that in other embodiments the advertising stations 12 may be located remote from one another by any distance (e.g., at different positions in a building, in different buildings, or even in different cities or countries).

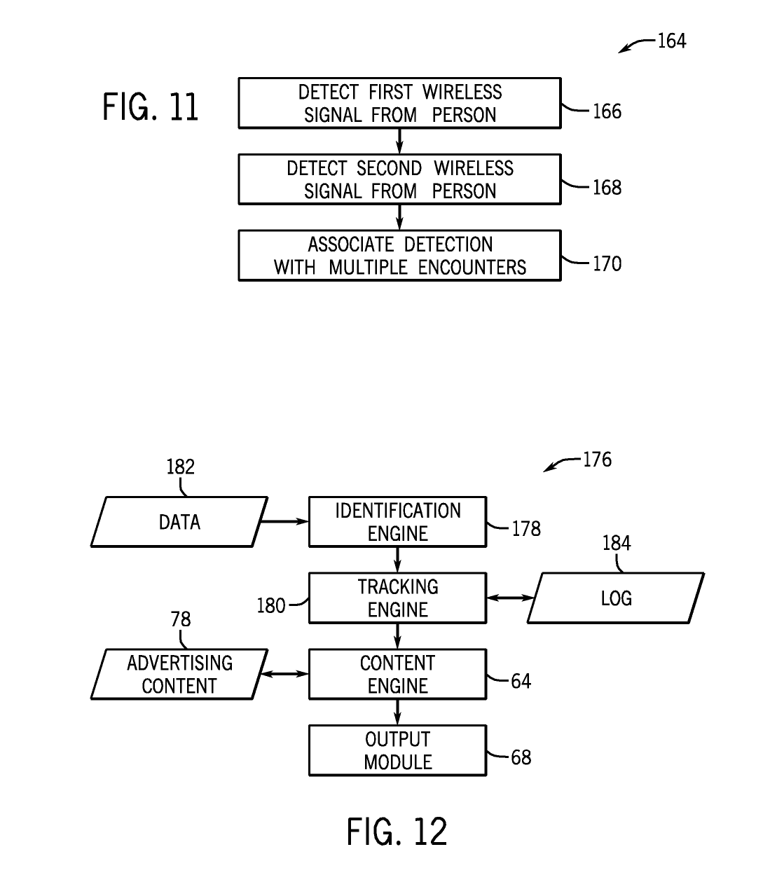

As noted above, wireless signals may be detected from electronic devices on persons near the advertising stations 12, such as radio-frequency signals or other wireless signals from mobile phones of such persons. In one embodiment generally depicted in FIG. 11, a method (represented by flowchart 164) includes detecting a first wireless signal from a person (block 166) during an encounter with an advertising station 12 and detecting a second wireless signal from a person (block 168) at a later time during a different encounter with the same advertising station 12 or a different advertising station 12. The data processing system 26 (or some other device) may detect that the first and second wireless signals received during different encounters are identical or related to one another and use such information to associate the detections with multiple encounters by a particular potential customer (block 170). In this way, the advertising system 10 may detect that a potential customer has had previous encounters and may use this information to tailor output from an advertising station 12 for that potential customer accordingly.

In some embodiments, the advertising system 10 may provide episodic content to increase both customer interest and the effectiveness of the advertising system 10. For example, the advertising system 10 may include content with an evolving storyline, playback of which is influenced by the potential customers interacting with one or more advertising stations 12 of the advertising system 10. In one embodiment, the advertising system 10 identifies and tracks individuals and encounters with advertising stations 12 such that content output to a specific user is targeted to that user based on previous interactions, allowing customer encounters to build on previous encounters and experiences with the potential customer. This in turn may lead to more engrossing long-term interactions between the advertising station 12 and potential customers, greater advertising impact on the potential customers, and potentially higher amounts of information exchange between advertisers and potential customers.

For example, in one embodiment generally represented by block diagram 176 in FIG. 12, an advertising system 10 includes an identification engine 178, a tracking engine 180, the content engine 64, and the output module 68, as described above. The identification engine 178 and the tracking engine 180 may also be provided in the form of application instructions executable to identify and track potential customers, and may be stored as routines in a device of the advertising system 10 (e.g., in a memory 34 or storage device 36 of the data processing system 26 or some other device). Particularly, the identification engine 178 may receive data 182, such as image data or other electronic data from which a potential customer may be identified. It is noted that identification of a potential customer includes recognizing a unique signature of the potential customer (e.g., facial features, electronic signal from device of potential customer, etc.) to enable determination of whether that potential customer has previously encountered one or more advertising stations 12 of the advertising system 10. Similarly, as used herein, the term identification with respect to such a potential customer does not require name identification of the potential customer, though such specific identification is not inconsistent with the present techniques.

The identification of a potential customer may be output to the tracking engine 180 by the identification engine 178, and the tracking engine 180 may reference a log 184 of customer encounters to determine whether the identified customer has had previous interactions with an advertising station 12 of the advertising system 10. Based on the existence, if any, of previous encounters, the content engine 64 may select the appropriate advertising content 78 for output via the output module 68. For example, with episodic content including ten episodes intended to be viewed sequentially, the advertising system 10 will be able to determine how many of the episodes have been output to the user in the past (e.g., via log 184) and may select the appropriate episode for current output (i.e., the next episode in the sequence) via the display 14 of an advertising station 12. Alternatively, episodes may be selected based on the results of previous interactions. For instance, the advertising system 10 may continue to output a particular episode of content to a user until the user takes a certain action (e.g., interacts in a certain way, solves a puzzle, takes and uses a coupon, etc.).

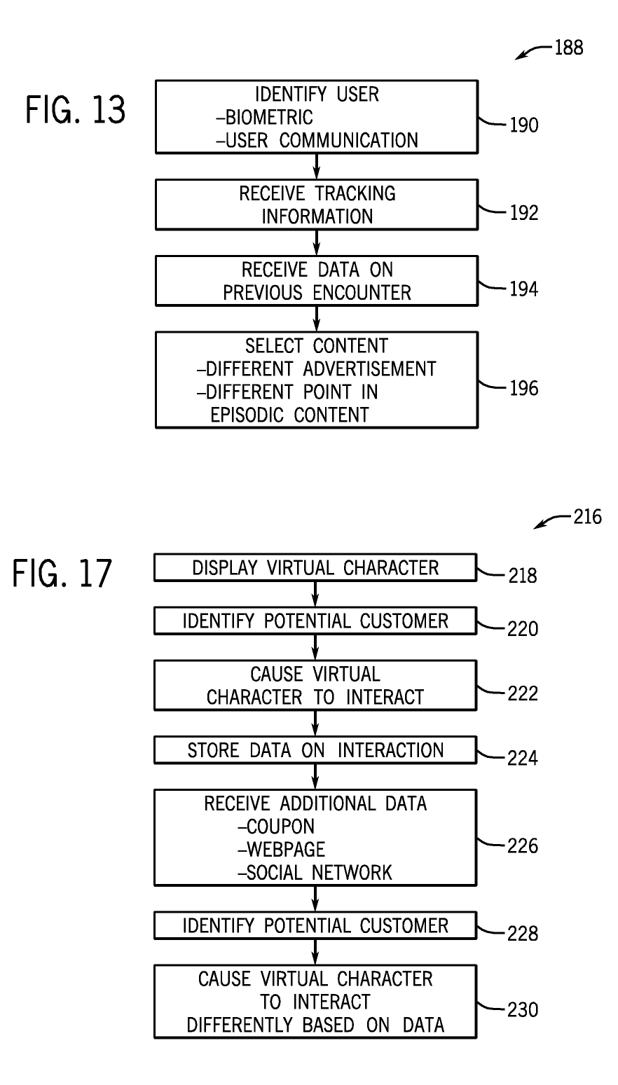

One example of such selection is represented by flowchart 188 in FIG. 13 in accordance with one embodiment. Particularly, the advertising system 10 may identify a user (block 190). Such identity may be established through any suitable methods. For example, identity may be established through biometric information, such as face or iris recognition, or by acquiring electronic signatures (e.g., RF signals) from electronic devices carried by the person to be identified. Additionally, identity may be established by inviting the customer to transmit identifying information from such an electronic device (e.g., through a website, a text message, a phone call, or a server communication). For instance, the display 14 of an advertising station 12 may provide a Quick Response code that may be captured by the potential customer (e.g., via a camera phone) and used to communicate identification or other information with a remote computer. Alternatively, the advertising station 12 may solicit the potential customer to transmit identifying information from a portable electronic device (e.g., by asking the customer to call or send a text to a specific number from the customer's mobile phone).

The data processing system 26 (e.g., the content engine 64) may receive tracking information (block 192) as well as data on one or more previous encounters (block 194). Based on such information and data, the content engine 64 may select appropriate content for the identified potential customer (block 196). For example, the content engine 64 may select a different point in episodic content (e.g., a different point in a story line) or may select a different advertisement altogether based on previous interactions with the identified potential customer (e.g., if the customer did not seem interested in the content in previous encounters, new content for a different product or service may be selected). The selected content may also be based on other factors, such as those discussed above (e.g., identified demographic information).

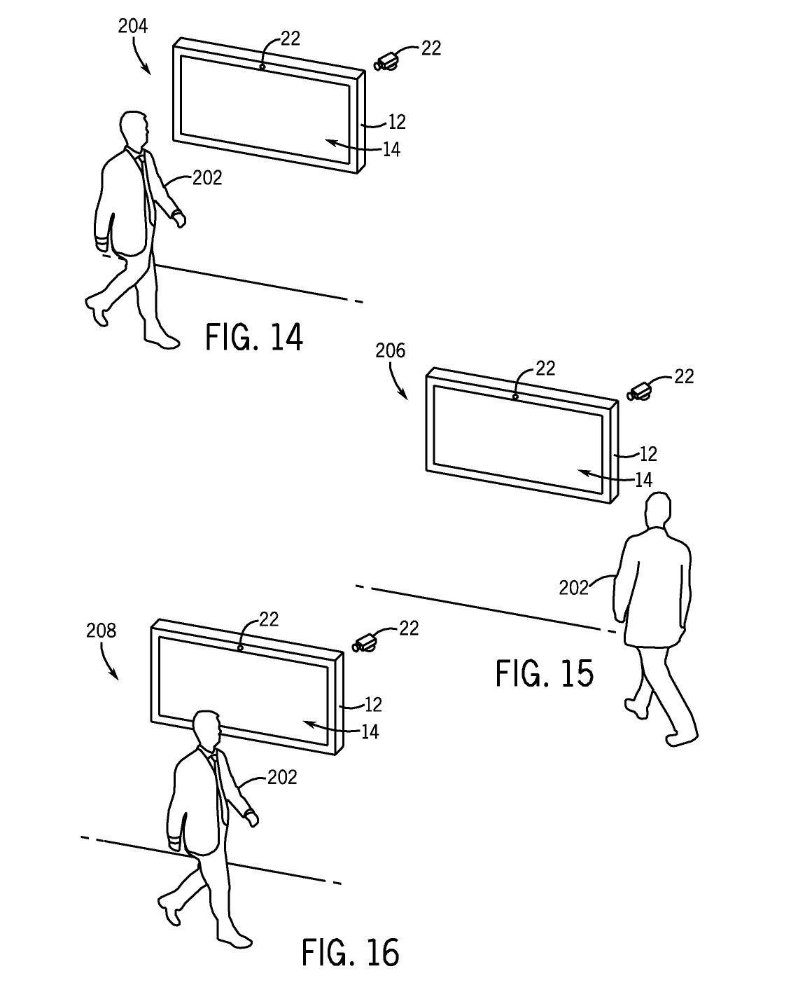

With reference to FIGS. 14-16, different portions of episodic content may be provided to a potential customer 202 at different times generally represented by reference numerals 204, 206, and 208. For instance, in FIG. 14, the potential customer 202 may encounter the advertising station 12 while traveling to a destination and encounter the advertising station 12 again (FIG. 15) when returning from that destination. Similarly, at a later time (e.g., such as the next day or week) depicted in FIG. 16, the potential customer 202 may encounter the advertising station 12 again. The use of episodic content allows the advertising station 12 to present different content to the potential customer 202 during each of these encounters to increase the likelihood of capturing the potential customer's attention and to increase the effectiveness of the advertising station 12.

In one embodiment, the advertising stations 12 may be used to introduce the potential customer to one or more virtual entities or characters that form relationships with the customer or with each other. During each encounter, a series of orchestrated events may occur which cause these relationships to evolve. Additionally, customer interaction may also cause evolution of such relationships. In subsequent encounters, the advertising station 12 (or other advertising stations 12 of the advertising system 10) may reestablish the identity of the potential customer, following which the virtual entities may continue to engage the potential customer based on the prior encounters (e.g., based on the existence of prior encounters or on data captured from the prior encounters).

For instance, in one embodiment generally represented by flowchart 216 in FIG. 17, a virtual character may be displayed to a potential customer (block 218). The advertising system 10 may identify the potential customer (block 220) and cause the virtual character or characters to interact with the customer or with each other (block 222). Further, the advertising system 10 may store data pertaining to the interaction and to the customer encounter for later use (block 224). Additionally, the advertising system 10 may receive and store additional data relevant to the potential customer (block 226), such as an identification that a coupon previously displayed to a customer has been redeemed, that a webpage associated with the advertising content has been accessed by the potential customer, information from a social network, or the like. For example, in one embodiment social network mechanisms, such as Facebook®, may allow for interactions via fan relationships. Alternatively, a potential customer could photograph an image provided by an advertising station 12 and then upload the image to access various web pages tailored to the user or the advertised content. Such techniques may also be used to facilitate identification, as described above. Also, these interactions may allow the customer to receive coupons or provide input to the advertising system 10 to influence the storyline of the content or the relationships (or characteristics) of virtual characters provided by the advertising system 10. Additionally, in one embodiment, potential customers can track a progression of the virtual characters via social media. For instance, a Facebook® page or other social media page may be provided to allow potential customers to access, via the Internet, information on and updates about the progression of such characters. Subsequently, in a new encounter with an advertising station 12, the advertising system 10 may identify the potential customer (block 228) and cause the virtual characters to interact differently with the potential customer (block 230) based on the previous encounters, interactions, or additional data.

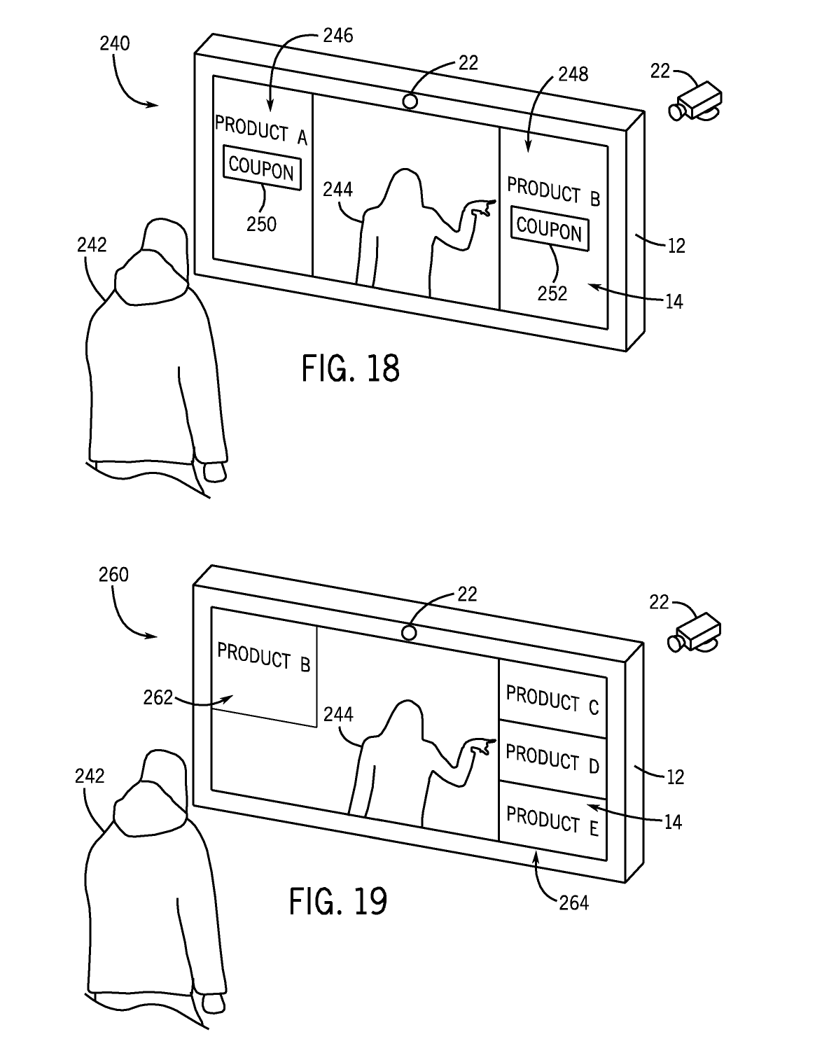

By way of further example, one encounter 240 between a potential customer 242 and an advertising station 12 is generally depicted in FIG. 18 in accordance with one embodiment. A virtual character 244 may be displayed by the advertising station 12 and provide information about alternative products (which may be depicted in regions 246 and 248 of the display 14). The potential customer 242 may interact with the virtual character 244 and may select one of the alternative products, such as Product B. Additionally, coupons 250 and 252 may be displayed or sent to the potential customer 242 for use by the potential customer in purchasing the advertised products.

In a later encounter 260 depicted in FIG. 19, following use of the coupon 252 for Product B and notification to the advertising system 10 (e.g., from the seller of the associated merchandise or service), the virtual character 244 may interact with the potential customer 242 with knowledge of such use of the coupon. For example, the virtual character 244 may inquire about the satisfaction of the customer 242 with the Product B (which may be shown in region 262 of the display 14), and may then recommend additional products based on the customer's satisfaction level, such as in region 264 of the display 14. For instance, if the customer indicates satisfaction with Product B, the virtual character 244 may recommend products similar to Product B or products that are liked by others who also liked Product B. And if the customer indicates dissatisfaction, the virtual character 244 may recommend alternative products. The later encounter 260 may occur at the same advertising station 12 as the previous encounter 240, or may occur at a different advertising station 12 of the advertising system 10.

Technical effects of the invention include improvements in interactive advertising efficiency, experience, and effectiveness. For instance, in one embodiment the decoupling of the analytics engine from the content engine along with the use of a transfer specification as described herein may provide a more scalable offering compared to previous approaches. The capture of usage characteristics may enable an operator or advertiser to determine the effectiveness of advertising content and an advertising station in some embodiments. Additionally, tracking of user encounters and the provision of episodic content in some embodiments may increase the effectiveness of advertising stations and their output content.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system to facilitate interactive advertising, the system comprising:
an advertising display configured to provide an advertisement to potential customers;
a camera configured to capture images of the potential customers when the potential customers pass the advertising display; and
an image processing system including a processor and a memory having application instructions for execution by the processor, the image processing system configured to execute the application instructions to derive usage characteristics of the potential customers with respect to the advertising display through analysis of the captured images.

2. The system of claim 1, comprising at least one additional camera configured to capture additional images of the potential customers when the potential customers pass the advertising display.

3. The system of claim 1, comprising at least one additional advertising display configured to provide the advertisement or a different advertisement to the potential customers or to additional potential customers.

4. The system of claim 3, comprising one or more additional cameras configured to capture images of the potential customers or the additional potential customers when passing the at least one additional advertising display.

5. The system of claim 1, wherein the advertising display is an interactive advertising display.

6. The system of claim 1, wherein the image processing system is configured to output a report to a user based on the derived usage characteristics.

7. A method to facilitate interactive advertising, the method comprising:
receiving imagery of a viewed area from a camera, the viewed area proximate an advertising station of an advertising system such that one or more potential customers may receive an advertisement from the advertising station when the one or more potential customers are within the viewed area;
electronically processing the received imagery to determine usage characteristics for the advertising station.

8. The method of claim 7, wherein electronically processing the received imagery includes generating statistics of a number of people that entered the viewed area over a given time period.

9. The method of claim 8, wherein electronically processing the received imagery includes measuring amounts of time associated with encounters between the advertising station and the number of people.

10. The method of claim 7, wherein electronically processing the received imagery includes estimating the age and gender of individuals depicted in the received imagery using soft biometric features.

11. The method of claim 7, wherein electronically processing the received imagery includes estimating the cultural affiliation of individuals depicted in the received imagery using soft biometric features.

12. The method of claim 7, wherein electronically processing the received imagery includes determining gaze directions of individuals in the viewed area.

13. The method of claim 12, comprising:
analyzing the determined gaze directions of the individuals to estimate interest levels of the individuals in content provided by the advertising station;
correlating the interest levels of the individuals with specific content provided by the advertising station to facilitate determination of advertising effectiveness of the specific content.

14. The method of claim 12, wherein electronically processing the received imagery includes analyzing facial expressions and body poses of the individuals.

15. The method of claim 14, comprising inferring emotional responses of the individuals to content provided by the advertising station based on the analysis of the facial expressions and the body poses.

16. The method of claim 7, wherein electronically processing the received imagery includes associating at least one potential customer of the one or more potential customers with multiple encounters with the advertising station.

17. The method of claim 7, wherein the advertising system includes a plurality of advertising stations, receiving imagery of a viewed area from a camera includes receiving imagery of multiple viewed areas proximate the plurality of advertising stations from multiple cameras, electronically processing the received imagery includes electronically processing the received imagery to determine usage characteristics for the plurality of advertising stations, and associating at least one potential customer of the one or more potential customers with multiple encounters with the plurality of advertising stations.

18. The method of claim 7, comprising:
detecting a first wireless signal from a portable device carried by at least one potential customer of the one or more potential customers within the viewed area;
detecting a second wireless signal from the portable device within the viewed area or within another area proximate an additional advertising station of the advertising system; and
associating the detection of the first and second wireless signals with multiple encounters by the at least one potential customer with the advertising station or with the advertising station and the additional advertising station.

19. The method of claim 7, comprising:
via the advertising station, displaying a coded coupon for a particular product or service to at least one potential customer of the one or more potential customers; and
receiving notification that the coded coupon was redeemed by the at least one potential customer.

20. The method of claim 7, comprising charging an amount for displaying the content based on the determined usage characteristics.

21. The method of claim 7, comprising modifying the placement of the advertising station based on the determined usage characteristics.

22. A manufacture comprising:
one or more non-transitory, computer-readable media having executable instructions stored thereon, the executable instructions comprising:
instructions adapted to receive image data depicting one or more potential customers near an advertising station; and
instructions adapted to electronically process the image data: to determine a number of potential-customer encounters at the advertising station, to determine demographic information for the potential customers, to determine emotional responses by the potential customers to content provided by the advertising station, to identify potential customers that have had multiple encounters with the advertising station, and to detect multiple encounters between at least one of the potential customers and the advertising station.
